(19) United States
(12) Patent Application Publication
(10) Pub. No.: US 2025/0210264 A1
(43) Pub. Date: Jun. 26, 2025

(54) MULTI-LAYERED CAPACITOR

(71) Applicant: SAMSUNG ELECTRO-MECHANICS CO., LTD., Suwon-si (KR)

(72) Inventors: Mingi Sin, Suwon-si (KR); Taegyun Kwon, Suwon-si (KR); Hyung Sub Woo, Suwon-si (KR); Inhye Kim, Suwon-si (KR); Jooyoung Kim, Suwon-si (KR); Geunwoo You, Suwon-si (KR); Kyung-Ryul Lee, Suwon-si (KR)

(73) Assignee: SAMSUNG ELECTRO-MECHANICS CO., LTD., Suwon-si (KR)

(21) Appl. No.: 18/955,357

(22) Filed: Nov. 21, 2024

(30) Foreign Application Priority Data
Dec. 22, 2023 (KR) 10-2023-0190110
Jul. 5, 2024 (KR) 10-2014-0089080

(51) Int. Cl. H01G 4/12; H01G 4/30

(52) U.S. Cl. CPC H01G 4/1227; H01G 4/30

(57) ABSTRACT

A multi-layered capacitor including a capacitor body including a dielectric layer and an internal electrode, and an external electrode disposed outside the capacitor body, wherein the dielectric layer includes a plurality of dielectric grains, and the dielectric grains have a cube shape and include a core containing barium (Ba) and titanium (Ti) oxide.

### CROSS-REFERENCE TO RELATED APPLICATIONS

This application claims priority to and the benefit of Korean Patent Application No. 10-2024-0089080 filed at the Korean Intellectual Property Office on Jul. 5, 2024, and Korean Patent Application No. 10-2023-0190110 filed in the Korean Intellectual Property Office on Dec. 22, 2023, the entire contents of which are incorporated herein by reference.

### BACKGROUND

### (a) Technical Field

The present disclosure relates to a multi-layered capacitor.

### (b) Description of the Related Art

In the past, multi-layered ceramic capacitors (MLCC) were focused on high-capacity products with high nominal dielectric constants, so it was required to secure high dielectric constants by increasing the size of the sintered dielectric grains of BaTiO₃, a dielectric material.

On the other hand, recently in the MLCC industry, as final products have become smaller and higher performing, securing effective dielectric constants (DC, high frequency, low electric field, etc.) has become more important than simply securing high dielectric constants. Accordingly, there is a need for technology development in the direction of controlling the overall microstructure, including the size and composition of dielectric grains in the thinned dielectric layer, to achieve excellent effective dielectric constants (DC, high frequency, low electric field, etc.), reliability (high temperature/humidity load), and temperature characteristics at the same time.

### SUMMARY

The present disclosure attempts to provide a multi-layered capacitor capable of simultaneously achieving an excellent dielectric constant (DC, high frequency, low electric field, etc.), reliability (high temperature/humidity load), and temperature (high temperature) characteristics.

An embodiment of the present disclosure provides a multi-layered capacitor, including a capacitor body including a dielectric layer and an internal electrode, and an external electrode disposed outside the capacitor body and on the capacitor body, wherein the dielectric layer includes a plurality of dielectric grains, and the plurality of dielectric grains include a cube-shaped core that includes a component including barium (Ba) and titanium (Ti) oxide.

A surface of the core may include predominantly a (001) crystal plane.

The plurality of dielectric grains may have an average size of 160 nm or less.

A standard deviation of a size of the plurality of dielectric grains may be 40 nm or less.

The core may have an average size of 120 nm or less.

A standard deviation of a size of the core may be 30 nm or less.

An average fraction of the core within the plurality of dielectric grains may be 60% or more.

The multi-layered capacitor may satisfy Equation 1 below.

[Equation 1]

Dₛ/D_{avg}≥0.7 (%/nm)

In Equation 1 above, Dₛ is a sintering relative density of the dielectric layer, and D_{avg} is an average size of the plurality of dielectric grains.

In the multi-layered capacitor, an average size of the plurality of dielectric grains may be 200 nm or less when a sintering relative density of the dielectric layer is 98%.

The plurality of dielectric grains may further include a shell disposed on the core, and the shell may include Dy, Mg, Mn, Tb, Sm, Si, Ba, Al, V, Nb, Sn, or a combination thereof.

The component may be represented by the following Chemical Formula 1:

[Chemical Formula 1]

Ba₍₁₋ₓ₎D1ₓTi_{(1-y)}D2_{y}O₃

In Formula 1, D1 is Dy, Tb, Sm, Nb, or a combination thereof, D2 is Mg, Mn, Si, Al, V, Dy, Tb, Sm, Sn, or a combination thereof, 0≤x<0.3, and 0≤y≤0.3.

In another embodiment of the present disclosure, a multi-layered capacitor includes a capacitor body including a dielectric layer and an internal electrode, and an external electrode disposed outside the capacitor body and on the capacitor body, wherein the dielectric layer includes a plurality of dielectric grains, and the plurality of dielectric grains include a cube-shaped core that includes a component including barium (Ba).

The component may further include titanium and oxygen.

The component may be represented by the following Chemical Formula 1:

[Chemical Formula 1]

Ba₍₁₋ₓ₎D1ₓTi_{(1-y)}D2_{y}O₃

In Formula 1, D1 is Dy, Tb, Sm, Nb, or a combination thereof, D2 is Mg, Mn, Si, Al, V, Dy, Tb, Sm, Sn, or a combination thereof, 0≤x≤0.3, and 0≤y≤0.3.

The plurality of dielectric grains may have an average size of 160 nm or less, a standard deviation of a size of the plurality of dielectric grains may be 40 nm or less, the core may have an average size of 120 nm or less, a standard deviation of a size of the core may be 30 nm or less, an average fraction of the core within the plurality of dielectric grains may be 60% or more, and a sintering relative density of the dielectric layer may be 95% or more and not more than 100%.

In yet another embodiment of the present disclosure, a method of manufacturing a multi-layered capacitor includes: mixing a first precursor including barium, a second precursor including titanium, alcohol, and water to form a reaction solution, heating the reaction solution to form cube-shaped particles including barium and titanium, forming a dielectric green sheet from a dielectric paste that includes the particles, forming a conductive paste layer on a surface of the dielectric green sheet, stacking a plurality of the dielectric green sheets having the conductive paste layer to prepare a dielectric green sheet laminate, firing the dielectric green sheet laminate to manufacture a capacitor body, and forming an external electrode on a surface of the capacitor body.

The alcohol may include at least one selected from methanol, ethanol, propanol, butanol, pentanol.

The first precursor may include at least one selected from Ba(OH)₂, Ba(OH)₂·8H₂O, and BaCl₂.

The second precursor may include at least one selected from TiO₂, titanium isopropoxide, titanium (IV) bis (ammonium lactato) dihydroxide, and TiCl₄.

The dielectric paste may further include hafnium (Hf).

The method may further include, after the heating of the reaction solution, coating the particles with Dy, Mg, Mn, Tb, Sm, Si, Ba, Al, V, Nb, Sn, or a combination thereof.

The multi-layered capacitor according to an embodiment of the present disclosure has the shape of dielectric grains containing barium titanium oxide appropriately controlled, thereby achieving excellent effective dielectric constant (DC, high frequency, low electric field, etc.), reliability (high temperature/humidity load), and temperature characteristics at the same time.

### BRIEF DESCRIPTION OF THE DRAWINGS

FIG. 1 is a perspective view of a multi-layered capacitor according to an embodiment of the present disclosure.

FIG. 2 is a cross-sectional view of the multi-layered capacitor taken along line I-I′ in FIG. 1.

FIG. 3 is an exploded perspective view showing a stacked structure internal electrodes in the capacitor body in FIG. 1.

FIG. 4 is a schematic view of dielectric grains and dielectric layers according to the present disclosure.

FIGS. 5A and 5B are each a schematic view of a core-shell structure of dielectric grains according to the related art and the present disclosure, respectively.

FIG. 6 is an HR-TEM image of BaTiO₃ powder prepared according to Example 1.

FIG. 7 is an HR-TEM image of BaTiO₃ powder prepared according to Comparative Example 1.

FIGS. 8 and 9 are a TEM image and a TEM-EDS image, respectively, observed by thin-film sampling of the dielectric layer of the MLCC manufactured according to Example 1 using FIB.

FIGS. 10 and 11 are a TEM image and a TEM-EDS image, respectively, observed by thin-film sampling of the dielectric layer of the MLCC manufactured according to Example 3 using FIB.

FIGS. 12 and 13 are a TEM image and a TEM-EDS image, respectively, observed by thin-film sampling of the dielectric layer of the MLCC manufactured according to Comparative Example 1 using FIB.

FIG. 14 is a graph showing the average size of dielectric grains in the dielectric layer and the sintering relative density of the dielectric layer according to the sintering temperature when manufacturing the MLCC dielectric layer using BaTiO₃ powder prepared according to Example 1, Example 3, and Comparative Example 1.

### DETAILED DESCRIPTION

Hereinafter, the present disclosure will be described in detail with reference to the accompanying drawings, in which embodiments of the present disclosure are shown. The drawings and description are to be regarded as illustrative in nature and not restrictive, and like reference numerals designate like elements throughout the specification. The accompanying drawings are intended only to facilitate an understanding of the embodiments disclosed in this specification, and it is to be understood that the technical ideas disclosed herein are not limited by the accompanying drawings and include all modifications, equivalents, or substitutions that are within the range of the ideas and technology of the present disclosure.

Although terms of “first,” “second,” and the like are used to explain various constituent elements, the constituent elements are not limited to such terms. These terms are only used to distinguish one constituent element from another constituent element.

When it is mentioned that a certain component is “coupled with” or “connected with” another component, it may be understood that another component can exist between the two components although the component can be directly coupled or connected with another component. Meanwhile, when it is mentioned that a certain component is “directly coupled with” or “directly connected with” another component, it is to be understood that another component does not exist between the two components.

Throughout the specification, the terms “comprise” or “have” are intended to specify the presence of stated features, integers, steps, operations, constituent elements, components or a combination thereof, but do not preclude the presence or addition of one or more other features, integers, steps, operations, constituent elements, components, and/or groups thereof. Therefore, unless explicitly described to the contrary, the term “comprise” and variations such as “comprises” or “comprising” will be understood to imply the inclusion of stated elements but not the exclusion of any other elements.

An embodiment of the present disclosure provides a multi-layered capacitor, including a capacitor body including a dielectric layer and an internal electrode, and an external electrode disposed outside the capacitor body, wherein the dielectric layer includes a plurality of dielectric grains, and the dielectric grains have a cube-shaped core containing barium (Ba) and titanium (Ti) oxide.

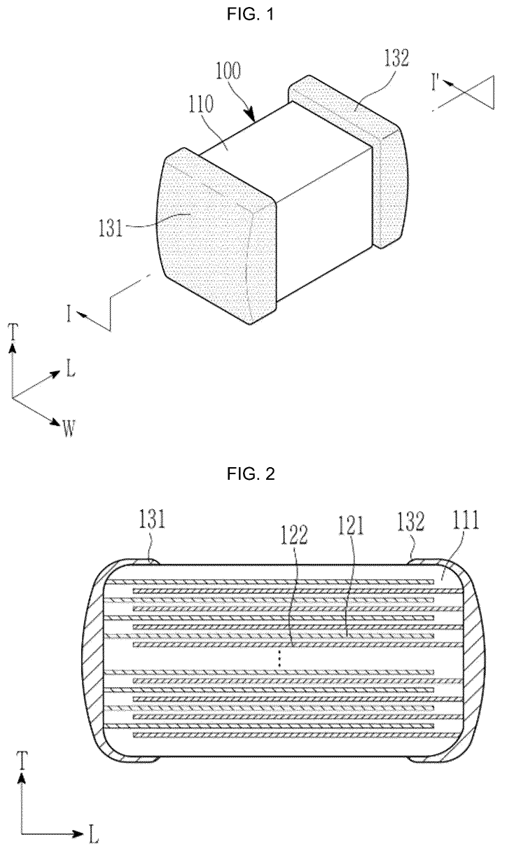

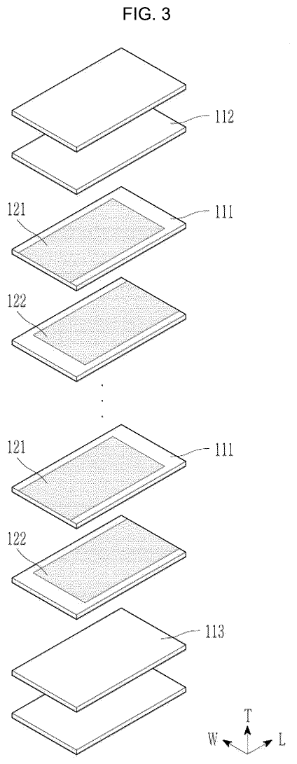

FIG. 1 is a perspective view of a multi-layered capacitor 100 according to an embodiment, FIG. 2 is a cross-sectional view of the multi-layered capacitor 100 taken along line I-I′ of FIG. 1, and FIG. 3 is an exploded perspective view showing a stacked structure of an internal electrode in a capacitor body 110 of FIG. 1.

When defining directions to clearly explain the present embodiment, the L-axis, W-axis, and T-axis shown in the drawing represent the length direction, width direction, and thickness direction of the capacitor body 110, respectively. Here, the thickness direction (T-axis direction) may be a direction perpendicular to the wide surface (main surface) of the sheet-shaped components, and may be used as the same concept as a stacking direction in which a dielectric layer 111 is stacked, for example. The length direction (L-axis direction) may be a direction extending parallel to the wide surface (main surface) of the sheet-shaped components, and may be approximately perpendicular to the thickness direction (T-axis direction). For example, the length direction (L-axis direction) may be the direction in which an external electrode 131 and a second external electrode 132 are disposed. The width direction (W-axis direction) may be a direction extending parallel to the wide surface (main surface) of the sheet-shaped components, and may be approximately perpendicular to the thickness direction (T-axis direction) and the length direction (L-axis direction). The length of the sheet-shaped components in the length direction (L-axis direction) may be longer than the length in the width direction (W-axis direction).

Referring to FIGS. 1 to 3, the multi-layered capacitor 100 according to the embodiment may include the capacitor body 110, and a first external electrode 131 and a second external electrode 132 disposed at both ends opposing in the longitudinal direction (L-axis direction) of the capacitor body 110.

For example, the capacitor body 110 may have a roughly hexahedral shape.

For convenience of description of the present embodiment, the two surfaces opposing each other in the thickness direction (T-axis direction) of the capacitor body 110 are referred to as first and second surfaces, the two surfaces connected to the first and second surfaces and opposing each other in the longitudinal direction (L-axis direction) are referred to as third and fourth surfaces, and two surfaces connected to the first and second surfaces and to the third and fourth surfaces and opposing each other in the width direction (W-axis direction) are referred to as fifth and sixth surfaces.

For example, the first surface, which is the lower surface, may be a surface facing the mounting direction. Additionally, the first to sixth surfaces may be flat, but the embodiment is not limited thereto. For example, the first to sixth surfaces may be curved surfaces with a convex central portion, and the edges, which are the boundaries of each surface, may be rounded.

The shape and size of the capacitor body 110 and the number of stacks of the dielectric layers 111 are not limited to those shown in the drawings of the embodiment.

The capacitor body 110 is a plurality of dielectric layers 111 stacked in the thickness direction (T-axis direction) and then fired, and include a first inner electrode 121 and a second inner electrode 122 alternately arranged in the thickness direction (T-axis direction) with the plurality of dielectric layers 111 interposed therebetween.

At this time, the boundaries between adjacent dielectric layers 111 of the capacitor body 110 may be integrated to the extent that it is difficult to check without using a scanning electron microscope (SEM).

Additionally, the capacitor body 110 may include an active region and cover regions 112 and 113.

The active region is a portion that contributes to forming the capacitance of the multi-layered capacitor 100. For example, the active region may be a region where the first inner electrode 121 or the second inner electrode 122 stacked along the thickness direction (T-axis direction) overlap.

The cover region 112 and 113 are thickness direction margin portions, and may be disposed on the first and second surfaces of the active region in the thickness direction (T-axis direction), respectively. The cover regions 112 and 113 may be a single dielectric layer 111 or two or more dielectric layers 111 stacked on the upper and lower surfaces of the active region, respectively.

Additionally, the capacitor body 110 may further include a side cover region. The side cover region is a width direction margin portion, and may be disposed on the fifth and sixth surfaces of the active portion in the width direction (W-axis direction), respectively. The side cover region may be formed by applying a conductive paste layer for the inner electrode layer on the surface of the dielectric green sheet, applying the conductive paste layer on only a part of the surface of the dielectric green sheet, and not applying the conductive paste layer on both sides of the surface of the dielectric green sheet, and then stacking the dielectric green sheets.

The cover regions 112 and 113 and the side cover region serve to prevent damage to the first inner electrode 121 and the second inner electrode 122 due to physical or chemical stress.

Hereinafter, the dielectric grains according to the present disclosure will be described in more detail.

The dielectric layer 111 according to the present disclosure includes a plurality of dielectric grains 1111.

In the past, multi-layered ceramic capacitors (MLCC) were focused on high-capacity products with a high nominal dielectric constant, so it was necessary to secure a high dielectric constant by increasing the size of dielectric grains made by sintering barium titanium oxide, a dielectric material. And for this purpose, conventional dielectric grains usually included a spherical core.

On the other hand, recently in the MLCC industry, as final products have become smaller and higher performing, securing an effective dielectric constant (DC, high frequency, low electric field, etc.) has become more important than simply securing a high dielectric constant, which requires controlling the overall microstructure, including the size and composition of the dielectric grains in the thin dielectric layer.

Accordingly, the present inventors studied methods for evenly distributing the size and size distribution of dielectric grains, and realized the importance of controlling the shape of the barium titanium oxide-containing core contained by the dielectric grains, and thus completed the present disclosure.

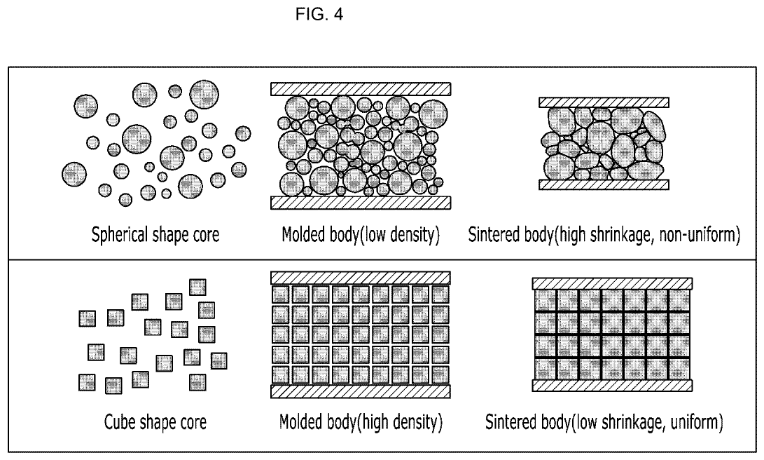

FIG. 4 is a schematic view of dielectric grains and dielectric layers according to the present disclosure.

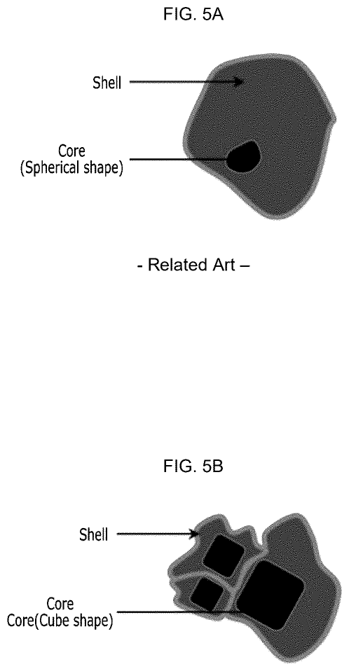

FIGS. 5A and 5B are each a schematic view of a core-shell structure of dielectric grains according to the related art and the present disclosure, respectively.

Referring to FIGS. 4 and 5B, the dielectric grain according to the present disclosure includes a core containing a component containing barium (Ba) and titanium (Ti) oxide, and in this case, the core has a cube shape. This is a shape that is clearly different from the sphere-shaped or amorphous dielectric grain core that has been commonly used in the past.

Specifically, the conventional barium titanium oxide-based dielectric grain core has a spherical, spherical-like, or amorphous shape. As an example, see FIG. 5A.

More specifically, a spherical or spherical-like dielectric grain core may be synthesized by a hydrothermal synthesis method using water as a reaction solvent when preparing barium titanium oxide. However, in the hydrothermal synthesis method, after forming a small seed, heat and pressure are applied to cause Ostwald ripening and grain growth, so the grain size distribution of the dielectric grains increases during the grain growth process.

Additionally, the dielectric grain core of an amorphous shape may be synthesized by a dry solid-phase synthesis method that does not use a solvent when preparing barium titanium oxide. However, the dry solid-phase synthesis method is synthesized through an in-situ mechanism, so as grain growth occurs to increase the grain size, the grain size distribution increases.

In other words, when the grain size of conventional spherical, spherical-like, or amorphous-shaped core-containing dielectric grains is increased to implement a high dielectric constant, the particle size distribution becomes too large, resulting in a decrease in effective dielectric constant or reliability. In addition, non-uniform grain growth had the problem of reducing the dielectric constant improvement effect by lowering the core fraction within the dielectric grains.

On the other hand, the dielectric grains according to the present disclosure have a cube-shaped core. Dielectric grains with the cube-shaped core may have a predominantly (001) crystal plane on the core surface. When the surface of the dielectric grain core is predominantly formed of the (001) plane, grain growth does not occur easily during the sintering process for preparing the dielectric layer due to the low surface energy, and the degree of suppression of grain growth is further increased when the particles are in face-to-face contact, which may effectively reduce the size and size dispersion of the dielectric grains. Additionally, as the size distribution of the dielectric grains is reduced, the degree of integration and density of the dielectric grains in the dielectric layer may be improved. Accordingly, it is possible to implement excellent effective dielectric constant (DC, high frequency, low electric field, etc.), reliability (high temperature/humidity load), and temperature characteristics of MLCC at the same time. Additionally, the fraction of the core within dielectric grains may be improved through uniform grain growth.

Meanwhile, the fact that the core surface of the dielectric grain is predominantly a (001) crystal plane may be confirmed through Fast-Fourier-transform (FFT) transformation analysis by observing the high resolution transmission electron microscope (HR-TEM) image of the dielectric grain core. More specifically, when observing HR-TEM images of the dielectric grain core surface and performing FFT transformation analysis, it can be confirmed that the (001), (011), (002), and (022) planes predominantly appear. Other methods and/or tools appreciated by one of ordinary skill in the art, even if not described in the present disclosure, may also be used.

Meanwhile, the cube-shaped dielectric grain core according to the present disclosure may be prepared by a liquid method when preparing barium titanium oxide powder, and may be implemented by using a mixed solvent of water and alcohol as a reaction solvent. This will be described in more detail in the manufacturing method described later.

Meanwhile, in this specification, “cube shape” refers to having an angular shape similar to a cube or rectangular parallelepiped, as distinguished from the conventional spherical, spherical-like, or amorphous dielectric grain core shape. This form may be confirmed by thin-film sampling of the dielectric layer within the MLCC with focused ion beam (FIB) and observing the dielectric grain core with a transmission electron microscope (TEM).

At this time, as an indicator that can quantitatively evaluate the degree of cube shape of the core, there may be an “average cube shape factor (A.C.S.F.)”, which may be calculated using the following method. First, the “cube shape factor (C.S.F.)” of the core for one dielectric grain is measured as follows. The dielectric layer in the MLCC is thin-film sampled with a FIB and observed with a TEM, the outer circumference of the dielectric grain core is measured, and the area (a) of a virtual square with the same outer circumference is calculated. Then, the area (b) of the actual dielectric grain core is calculated. Afterwards, the “cube shape factor (C.S.F.)” of the core for one dielectric grain may be obtained by calculating the value of (b)/(a). Next, the “average cube shape factor (A.C.S.F.)” may be obtained by calculating the average of the “cube shape factor (C.S.F.)” derived in the same method for 20 random dielectric grain cores.

At this time, the “average cube shape factor (C.S.F.)” of the dielectric grain core according to the present disclosure is 0.80 or more or 0.85 or more, which may be close to the ideal cube shape. Other methods and/or tools appreciated by one of ordinary skill in the art, even if not described in the present disclosure, may also be used.

Meanwhile, the dielectric grains according to the present disclosure have a cube-shaped core, so that grain growth is controlled during sintering for manufacturing the dielectric layer, and the average size may be sufficiently small, such as 160 nm or less, more specifically, 150 nm or less. Accordingly, it is possible to implement an excellent effective dielectric constant (DC, high frequency, low electric field, etc.), reliability (high temperature/humidity load), and temperature characteristics of MLCC at the same time.

In this specification, the “average size of dielectric grains” may be obtained by calculating the average of the maximum diameters of 20 random dielectric grains when thin-film sampling of the dielectric layer in the MLCC with FIB and observation with a TEM. Other methods and/or tools appreciated by one of ordinary skill in the art, even if not described in the present disclosure, may also be used.

In addition, the dielectric grains according to the present disclosure have a cube-shaped core, so that grain growth is controlled during sintering for manufacturing the dielectric layer, and the standard deviation of the size may be sufficiently small, such as 60 nm or less, and more specifically, 40 nm or less. Accordingly, it is possible to implement an excellent effective dielectric constant (DC, high frequency, low electric field, etc.), reliability (high temperature/humidity load), and temperature characteristics of MLCC at the same time.

In this specification, the “standard deviation of dielectric grain size” may be obtained by calculating the standard deviation of the maximum diameters of 20 random dielectric grains when thin-film sampling of the dielectric layer in the MLCC with FIB and observation with a TEM. Other methods and/or tools appreciated by one of ordinary skill in the art, even if not described in the present disclosure, may also be used.

Additionally, the grain growth of the core within the dielectric grain according to the present disclosure may be controlled so that the average size may be 120 nm or less, and more specifically, 100 nm or less. Accordingly, it is possible to implement an excellent effective dielectric constant (DC, high frequency, low electric field, etc.), reliability (high temperature/humidity load), and temperature characteristics of MLCC at the same time.

In this specification, the “average size of the core within a dielectric grain” may be obtained by calculating the average of the maximum diameters of 20 cores within a random dielectric grain when thin-film sampling of the dielectric layer within the MLCC with FIB and observation with a TEM. Other methods and/or tools appreciated by one of ordinary skill in the art, even if not described in the present disclosure, may also be used.

In addition, the grain growth of the core in the dielectric grain according to the present disclosure may be controlled so that the standard deviation of the size may be 30 nm or less, and more specifically, 25 nm or 20 nm or less. Accordingly, it is possible to implement an excellent effective dielectric constant (DC, high frequency, low electric field, etc.), reliability (high temperature/humidity load), and temperature characteristics of MLCC at the same time.

In this specification, the “standard deviation of the size of the core within the dielectric grains” may be obtained by calculating the standard deviation of the maximum diameters of 20 cores within a random dielectric grain when thin-film sampling of the dielectric layer within the MLCC with FIB and observation with a TEM. Other methods and/or tools appreciated by one of ordinary skill in the art, even if not described in the present disclosure, may also be used.

On the other hand, by having a cube-shaped core, the dielectric grain according to the present disclosure may induce a uniform grain growth, thereby improving the fraction of the core in the dielectric grain. Accordingly, the average fraction of the core within the dielectric grain according to the present disclosure may be 60% or more, and more specifically, 65% or more. When the average fraction of the core within the dielectric grain is sufficiently large, it is possible to implement a high dielectric constant.

In this specification, the “average fraction of the core within the dielectric grain” may be obtained by calculating the average of the ratio of the total area of core to the total area of dielectric grains for 20 random dielectric grains when thin-film sampling of the dielectric layer within the MLCC with FIB and observation with a TEM. Other methods and/or tools appreciated by one of ordinary skill in the art, even if not described in the present disclosure, may also be used.

In addition, the multi-layered capacitor according to the present disclosure may additionally satisfy Equation 1 below.

[Equation 1]

Dₛ/D_{avg}≥ 0.7 (%/nm)

In Equation 1 above, Dₛ is the sintering relative density of the dielectric layer, and D_{avg} is the average size of the dielectric grains.

More specifically, in general, as the sintering temperature for manufacturing the dielectric layer increases, the average size of the dielectric grains increases and the sintering relative density tends to improve at the same time. The sintering relative density may be obtained from the porosity of the dielectric layer or may be calculated by dividing the density of the dielectric layer by the true density of the components constituting the dielectric layer. Other methods and/or tools appreciated by one of ordinary skill in the art, even if not described in the present disclosure, may also be used.

However, conventional spherical or amorphous core-containing dielectric grain particles require at least 200 nm as the average size of the dielectric grain to obtain a high sintering relative density of 80% or more, which results in a good sintering relative density but an uneven grain size distribution, resulting in poor effective dielectric constant or reliability.

On the other hand, since the dielectric layer in the multi-layered capacitor according to the present disclosure includes dielectric grains containing a cube-shaped core, densified sintering may be realized by controlling the grain growth, thereby improving the integration of the dielectric grains in the dielectric layer, and accordingly, a high sintering relative density can be implemented even if the average size of the dielectric grains is small, satisfying Equation 1. As a result, the effective dielectric constant and reliability of MLCC may be improved.

In an embodiment, the multi-layered capacitor according to the present disclosure may have an average size of 200 nm or less of dielectric grains when the sintering relative density of the dielectric layer is 98%, more specifically, 150 nm or less or 137.5 nm or less. Accordingly, a high sintering relative density may be achieved even if the average size of the dielectric grains is small, and as a result, the effective dielectric constant and reliability of the MLCC may be improved.

The above-described reduction in the average size and size standard deviation of the dielectric grains, the reduction in the average size and size standard deviation of the cores within the dielectric grains, and the more desirable implementation of good sintering relative density at relatively small dielectric grain average sizes may be obtained by more precisely controlling the average particle diameter (D50) of the titanium raw material used as the barium titanium oxide raw material. This will be described in more detail in the manufacturing method described later.

Meanwhile, the dielectric grain according to the present embodiment may further include a shell disposed on the core, and the shell may contain Dy, Mg, Mn, Tb, Sm, Si, Ba, Al, V, Nb, Sn, or a combination thereof. When the shell is formed of the above composition, the grain growth control effect may be more preferably implemented.

In addition, the component presented in the core according to the present disclosure may be more specifically represented by the following Chemical Formula 1.

[Chemical Formula 1]

Ba₍₁₋ₓ₎D1ₓTi_{(1-y)}D2_{y}O₃

In Formula 1, D1 is Dy, Tb, Sm, Nb, or a combination thereof, D2 is Mg, Mn, Si, Al, V, Dy, Tb, Sm, Sn, or a combination thereof, 0≤x≤0.3, and 0≤y≤0.3.

A method for manufacturing a multi-layered capacitor according to another embodiment of the present disclosure will now be described.

Another embodiment of the present disclosure provides a method for manufacturing a multi-layered capacitor, including preparing a dielectric powder, preparing a dielectric green sheet using the dielectric powder and forming a conductive paste layer on a surface of the dielectric green sheet, stacking the dielectric green sheet having the conductive paste layer formed to prepare a dielectric green sheet laminate, firing the dielectric green sheet laminate to manufacture a capacitor body including a dielectric layer and an inner electrode, and forming an outer electrode on a first surface of the capacitor body, wherein the dielectric layer includes a plurality of dielectric grains, and the dielectric grains have a cube shape.

Hereinafter, the method for manufacturing the multi-layered capacitor according to the present disclosure will be described in detail step by step.

First, prepare a dielectric powder.

The preparing of the dielectric powder may include forming core particles that contain barium titanium oxide and have a cube shape.

At this time, the forming of the core particles may include, more specifically, mixing barium raw materials (e.g., a first precursor), titanium raw materials (e.g., a second precursor), water, and alcohol to form a reaction solution; and heat treating the reaction solution.

In this way, by using a mixed alcohol aqueous solution of water and alcohol as a solvent in the reaction solution, the dielectric grain core may be implemented in the form of a cube.

More specifically, the alcohol may be methanol, ethanol, propanol, butanol, pentanol, or a combination thereof.

The average particle diameter of the titanium raw material may be 10 to 40 nm, and more specifically, 15 to 35 nm or 25 to 35 nm. When the average particle diameter of the titanium raw material satisfies the above range, the reduction in the average size and size standard deviation of the dielectric grains, the reduction in the average size and size standard deviation of the cores within the dielectric grains, and the good sintering relative density at relatively small dielectric grain average sizes may be more preferably implemented. Meanwhile, the average particle diameter of the titanium raw material may be obtained by calculating the average of the longest side lengths of 30 random particles when observing SEM or TEM images of the titanium raw material powder.

The barium raw material is not particularly limited, but may be, for example, Ba(OH)₂, Ba(OH)₂·8H₂O, BaCl₂, or a combination thereof.

The titanium raw material is not particularly limited, but may be, for example, TiO₂, titanium isopropoxide (TTIP), titanium (IV) bis (ammonium lactato) dihydroxide (TALH), TiCl₄, or a combination thereof.

Meanwhile, the preparing of the dielectric powder may further include forming a shell on the core particle after the forming of the core particles that contain barium titanium oxide and have a cube shape.

The forming of the shell on the core particles may include forming a coating solution containing coating raw materials, and adding the core particles to the coating solution and then performing a coating heat treatment to form a shell.

The coating raw material may be a Dy compound, Mg compound, Mn compound, Tb compound, Sm compound, Si compound, Ba compound, Al compound, V compound, Nb compound, Sn compound, or a combination thereof.

Next, manufacturing of the capacitor body will be described.

In the manufacturing process of the capacitor body, a dielectric paste that becomes a dielectric layer after firing and a conductive paste that becomes an inner electrode after firing are prepared.

The dielectric paste is manufactured in the following method, for example. The prepared dielectric powder doped with hafnium (Hf) is uniformly mixed by means such as wet-mixing, dried, and then heat-treated under predetermined conditions to obtain calcined powder. An organic vehicle or an aqueous vehicle is added to the obtained calcined powder and kneaded to prepare a dielectric paste.

A dielectric green sheet is obtained by forming the obtained dielectric paste into a sheet using a technique such as the doctor blade method. Additionally, the dielectric paste may contain additives selected from various dispersants, plasticizers, dielectrics, accessory component compounds, or glass, if necessary.

The conductive paste for internal electrodes is prepared by mixing a conductive powder made of a conductive metal or an alloy thereof with a binder or solvent. The conductive paste for internal electrodes may, if necessary, contain a ceramic powder (for example, barium titanate powder) as a co-material. The co-material may act to suppress sintering of the conductive powder during the firing process.

The conductive paste for internal electrodes is applied to the surface of the dielectric green sheet in a predetermined pattern using various printing methods such as screen-printing or transfer methods. Then, a dielectric green sheet laminate structure is prepared by stacking a plurality of layers of dielectric green sheets on which internal electrode patterns are formed, and then pressing the plurality of layers of dielectric green sheets in the stacking direction. At this time, the dielectric green sheet and the internal electrode pattern may be stacked so that the dielectric green sheet is positioned on the upper and lower surfaces of the dielectric green sheet laminate structure in the stacking direction.

Optionally, the obtained dielectric green sheet laminate structure may be cut to a predetermined size by dicing or the like.

Additionally, the dielectric green sheet laminate structure may be solidified and dried to remove plasticizers, etc., if necessary, and after solidified and dried, the dielectric green sheet laminate structure may be barrel polished using a horizontal centrifugal barrel machine, and the like. In barrel polishing, the dielectric green sheet laminate structure is placed into a barrel container with media and polishing liquid, and rotational motion or vibration is applied to the barrel container, thus unnecessary parts, such as burrs generated during cutting, may be polished. Additionally, after barrel polishing, the dielectric green sheet laminate structure may be washed with a cleaning solution such as water, and dried.

The capacitor body is obtained after binder removal treatment and firing of the dielectric green sheet laminate structure.

The conditions for binder removal may be appropriately adjusted depending on the main components of the dielectric layer or the internal electrode layer. For example, the rate of temperature rise during binder removal treatment may be 5° C./hour to 300° C./hour, the support temperature may be 180° C. to 400° C., and the temperature holding time may be 0.5 hours to 24 hours. The treatment atmosphere of the binder removal may be air or a reducing atmosphere.

The conditions for the firing may be appropriately adjusted depending on the main components of the dielectric layer or the internal electrode layer. For example, the temperature during firing may be 1200° C. to 1350° C., or 1220° C. to 1300° C., and the time may be 0.5 hours to 8 hours, or 1 hour to 3 hours. The firing atmosphere may be a reducing atmosphere, for example, an atmosphere in which a mixed gas of nitrogen gas (N₂) and hydrogen gas (H₂) is humidified. When the internal electrode includes nickel (Ni) or a nickel (Ni) alloy, the oxygen partial pressure in the firing atmosphere may be 1.0×10⁻¹⁴ MPa to 1.0×10⁻¹⁰ MPa.

After the firing, annealing may be performed as needed. Annealing is a treatment to reoxidize the dielectric layer, and annealing may be performed if firing is performed in a reducing atmosphere. The conditions of the annealing treatment may also be appropriately adjusted depending on the main component composition of the dielectric layer. For example, the annealing temperature may be 950° C. to 1150° C., the time may be 0 to 20 hours, and the rate of temperature rise may be 50° C./hour to 500° C./hour. The annealing atmosphere may be a humidified nitrogen gas (N₂) atmosphere, and the oxygen partial pressure may be 1.0×10⁻⁹ MPa to 1.0×10⁻⁵ MPa.

In binder removal treatment, sintering treatment, or annealing treatment, for example, a wetter may be used to humidify nitrogen gas or mixed gas. In this case, the water temperature may be 5° C. to 75° C. The binder removal treatment, firing treatment, and annealing treatment may be performed sequentially or independently.

Optionally, surface treatment such as sand blasting, laser irradiation, barrel polishing, etc. may be performed on the third and fourth surfaces of the obtained capacitor body. By performing this surface treatment, the ends of the first internal electrode and the second internal electrode may be exposed to the outermost surfaces of the third and fourth surfaces, and thus the electrical connection between the first external electrode and the second external electrode, and the first internal electrode and the second internal electrode, may be improved, so alloy portions may be easily formed.

A paste for forming a sintered metal layer may be applied using an external electrode on the outer surface of the obtained capacitor body, and then sintered to form a sintered metal layer.

The paste for forming the sintered metal layer may include a conductive metal and glass. Since the description of the conductive metal and glass is the same as described above, repeated description will be omitted. In addition, the paste for forming the sintered metal layer may optionally include secondary components such as a binder, solvent, dispersant, plasticizer, or oxide powder. The binder may be, for example, ethylcellulose, acrylic, butyral, etc., and the solvent may be, for example, an organic solvent or aqueous solvent such as terpineol, butylcarbitol, alcohol, methyl ethyl ketone, acetone, toluene, and the like.

Methods for applying the paste for forming the sintered metal layer on the outer surface of the capacitor body may include various printing methods such as a dip method and screen-printing, an application method using a dispenser, etc., and a spraying method using a spray. The paste for forming the sintered metal layer may be applied to at least the third and fourth surfaces of the capacitor body, and optionally applied to a part of the first, second, fifth, or sixth surfaces on which the band portions of the first and second external electrodes are formed.

Thereafter, the capacitor body onto which the paste for forming the sintered metal layer is applied is dried and sintered at a temperature of 700° C. to 1000° C. for 0.1 to 3 hours to form the sintered metal layer.

Optionally, a paste for forming a conductive resin layer may be applied to the outer surface of the obtained capacitor body and then cured to form a conductive resin layer.

The paste for forming the conductive resin layer may include a resin and, optionally, a conductive metal or a non-conductive filler. Since the description of the conductive metal and resin is the same as described above, repeated description will be omitted. Additionally, the paste for forming the conductive resin layer may optionally include accessory components such as a binder, solvent, dispersant, plasticizer, or oxide powder. For example, the binder may be, for example, ethylcellulose, acrylic, butyral, etc., and the solvent may be an organic solvent or aqueous solvent such as terpineol, butylcarbitol, alcohol, methyl ethyl ketone, acetone, and toluene.

For example, the method of forming the conductive resin layer may be formed by dipping the capacitor body 110 in a paste for forming the conductive resin layer and then curing it, or by printing the paste for forming the conductive resin layer on the surface of the capacitor body 110 by a screen-printing method or a gravure printing method, or by applying the paste for forming the conductive resin layer to the surface of the capacitor body 110 and then curing it.

Next, a plating layer is formed on the outside of the conductive resin layer.

For example, the plating layer may be formed by a plating method, sputtering, or electrolytic plating (electric deposition).

The above-described embodiments will be described in more detail through examples below. However, the following examples are for illustrative purposes only and do not limit the scope of appended claims.

### Example 1

### (1) Preparation of Dielectric Powder

(Formation of reaction solution) First, Ba(OH)₂ and TiO₂ powder were added to the alcohol aqueous reaction solution solvent mixed with water and ethanol, in an amount adjusted to the stoichiometric ratio of BaTiO₃, the final core compound, to form a reaction solution. At this time, the average particle diameter of TiO₂ was 29 nm.

(Heat treatment and drying) The reaction solution was then heat treated and dried to form BaTiO₃ powder (core).

(Formation of coating solution) Then, coating raw materials containing one or more of Dy, Mg, Mn, Tb, Sm, Si, Ba, Al, V, Nb, and Sn are added to ethanol or ethanol-toluene mixed solvent to form a coating solution.

(Coating heat treatment) After adding the core particles to the coating solution, coating heat treatment is performed at 400° C. for 2 hours to prepare dielectric grains with a shell containing one or more of the elements Dy, Mg, Mn, Tb, Sm, Si, Ba, Al, V, Nb, and Sn.

### (2) Manufacturing of Multi-Layered Capacitor

As a dielectric base material, the dielectric grains were mixed with ethanol/toluene, a dispersant, and a binder, and then mechanically milled to prepare a dielectric slurry.

Afterwards, the prepared dielectric slurry was used to prepare the dielectric green sheet using an on-roll molding coater.

Afterwards, a conductive paste layer containing nickel (Ni) was printed on the surface of the dielectric green sheet, and the dielectric green sheet (width×length×height=3.2 mm×2.5 mm×2.5 mm) with the conductive paste layer formed was stacked and pressed to prepare a dielectric green sheet laminate.

Afterwards, the dielectric green sheet laminate was fired (sintered) under conditions of 400° C. or lower, in a nitrogen atmosphere through a plasticizing process, and then fired (sintered) at a sintering temperature of 1300° C. or lower, with a hydrogen concentration of 1.0% H₂ or less, to manufacture the capacitor body. Then, an external electrode was formed on the outside of the capacitor body to manufacture a multi-layered capacitor.

### Other Examples and Comparative Examples

A multi-layered capacitor was manufactured in the same manner as in Example 1, except that the process conditions compared to Example 1 were modified as shown in Table 1 below.

(In Table 1 below, Examples 1 and 2, Examples 3 and 4, and Comparative Examples 1 and 2 were carried out twice under the same process conditions.)

TABLE 1

| | | TiO₂ average particle |
|---|---|---|
| | Reaction solvent | diameter (D50) (nm) |
| Example 1 | Alcohol aqueous solution | 29 |
| Example 2 | Alcohol aqueous solution | 29 |
| Example 3 | Alcohol aqueous solution | 5 |
| Example 4 | Alcohol aqueous solution | 5 |
| Comparative | Water | 15 |
| Example 1 | | |
| Comparative | Water | 15 |
| Example 2 | | |

Tables 2 to 5 below summarize the physical property evaluation results of the dielectric grains and the performance evaluation results of the MLCC according to Experimental Examples 2 to 4 described later.

TABLE 2

| | | | | | | | | | Average |
|---|---|---|---|---|---|---|---|---|---|
| | | | | | | | | | size of |
| | | | | | | | | | dielectric |
| | | | | | | | | | grains |
| | | | | | | | | | when |
| | | | | | | | | | sintering |
| | | | | | | | | | relative |
| | | | | | | | | | density |
| | | | | Grain | | Core | | | of |
| | | | Grain | size | Core | size | Core | Whether | dielectric |
| | | | average | standard | average | standard | average | satisfied | layer is |
| | Core | | size | deviation | size | deviation | fraction | Equation | 98% |
| | shape | A.C.S.F | (nm) | (nm) | (nm) | (nm) | (area %) | 1 | (nm) |
| Example 1 | Cube | 93% | 142 | 36.4 | 97 | 18.5 | 70 | O | 136 |
| Example 2 | Cube | 92% | 136 | 35.8 | 97 | 18.1 | 71 | O | 128 |
| Example 3 | Cube | 88% | 143 | 44.9 | 104 | 33.4 | 73 | X | 139 |
| Example 4 | Cube | 90% | 148 | 47 | 99 | 37.3 | 67 | X | 148 |
| Comparative | Spherical | 76% | 697 | 205.9 | 136 | 22 | 20 | X | 650 |
| Example 1 | shape | | | | | | | | |
| Comparative | Spherical | 78% | 536 | 173.7 | 123 | 31 | 23 | X | 483 |
| Example 2 | shape | | | | | | | | |

TABLE 3

| | | | TCC capacity variation |
|---|---|---|---|
| | DC variation ratio | | ratio |
| | 1 V, 3 V/μm | Step IR MTTF | −55° C./125° C. |
| Example 1 | −17%/−68% | 54.9 h | 13% |
| Example 2 | −18%/−69% | 50 h | 14% |
| Example 3 | −21%/−72% | 45.5 h | 14% |
| Example 4 | −19%/70% | 49.4 h | 14% |
| Comparative | −27%/−77% | 32.5 h | 16% |
| Example 1 | | | |
| Comparative | −26%/−77% | 34 h | 15% |
| Example 2 | | | |

Experimental Example 1: Barium titanium oxide powder HR-TEM image and surface crystal plane analysis

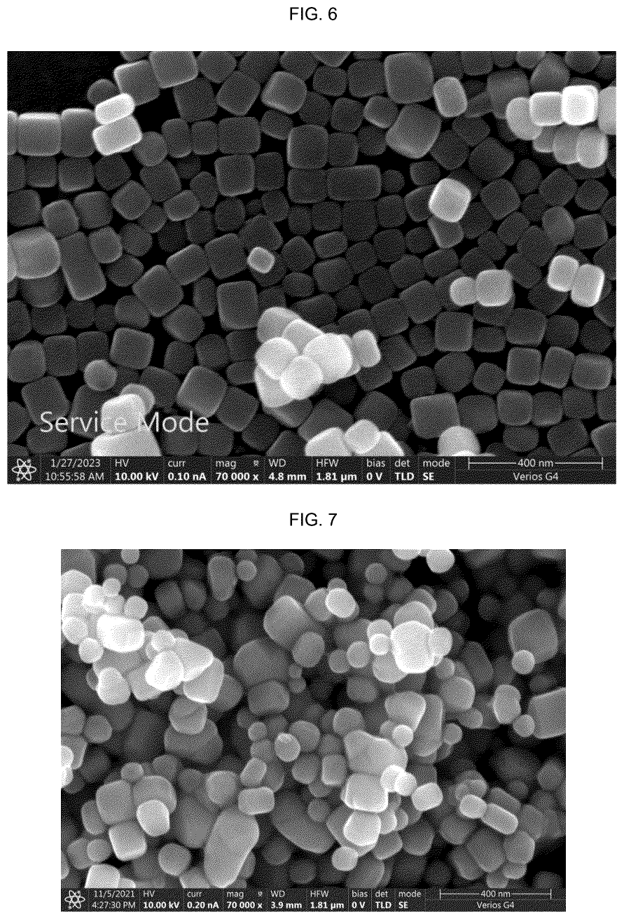

The barium titanium oxide powder prepared according to Example 1 and Comparative Example 1 was subjected to HR-TEM image analysis, which is shown in FIGS. 6 and 7, respectively. In addition, surface crystal plane analysis was performed on HR-TEM images through FFT transformation analysis.

In the case of Example 1, it can be seen that the core surface is predominantly a (001) crystal plane, as the surface has a cube-shaped core, or the surface was analyzed as the (001) and (011) planes through FFT analysis.

On the contrary, in the case of Comparative Example 1, the cube-shaped core cannot be seen, and low index faces such as (001), (011), and (111) planes are also analyzed in the FFT analysis, and it can be seen that the core surface had a lower degree of (001) plane dominance compared to Example 1.

### Experimental Example 2: Evaluation of Dielectric Grain Shape and Physical Properties in the Dielectric Layer

### (1) Evaluation of Dielectric Grain and Core Shape

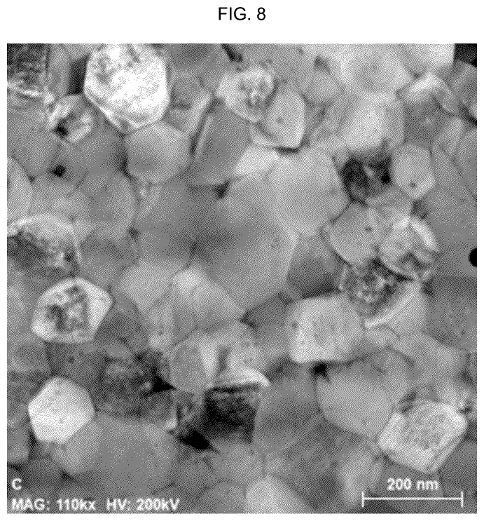

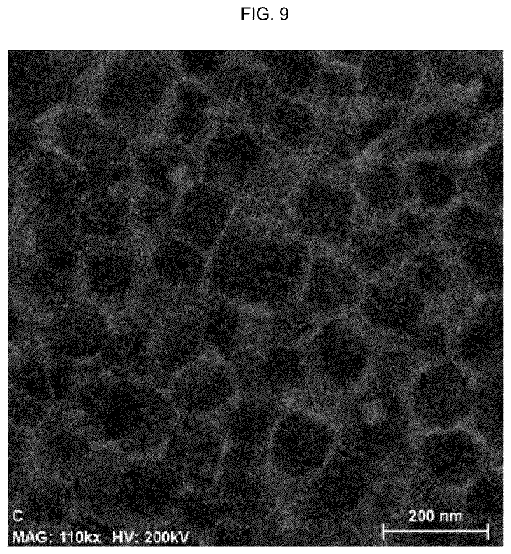

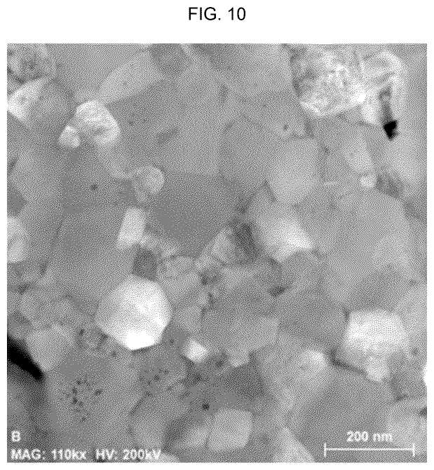

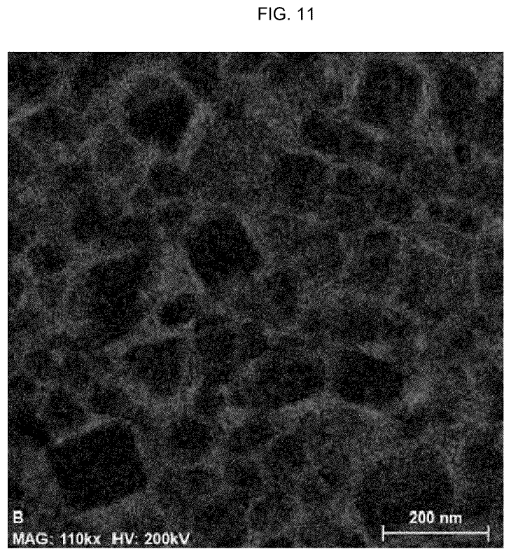

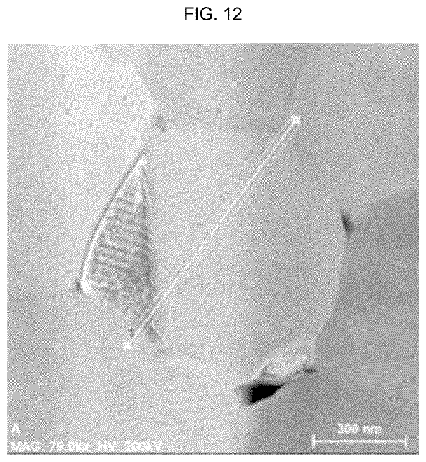

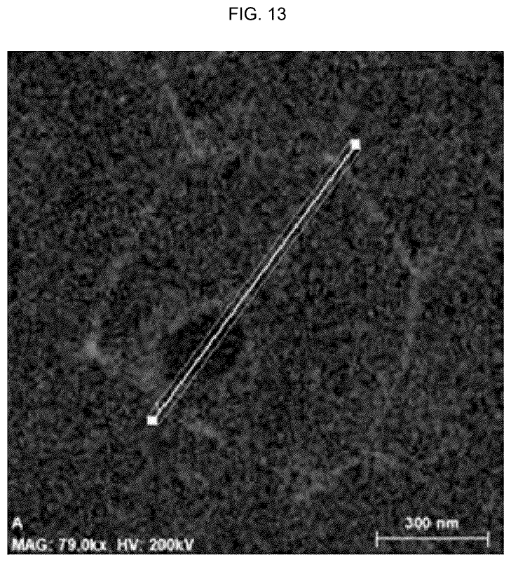

The dielectric layers of the MLCC manufactured according to Example 1, Example 3, and Comparative Example 1 were thin-film sampled using FIB and observed with transmission electron microscopy coupled with energy dispersive X-ray spectroscopy (TEM-EDS). The images are shown in FIGS. 8 and 9 (Example 1), FIGS. 10 and 11 (Example 3), and FIGS. 12 and 13 (Comparative Example 1).

### (2) Average Cube Shape Factor (A.C.S.F.) Evaluation

As a method to quantitatively evaluate the degree of cube shape of the dielectric grain core, the “average cube shape factor (A.C.S.F.)” was calculated using the method below.

First, the “cube shape factor (C.S.F.)” of the core for one dielectric grain is measured as follows. The dielectric layer in the MLCC is thin-film sampled with a FIB and observed with a TEM, the outer circumference of the dielectric grain core is measured, and the area (a) of a virtual square with the same outer circumference is calculated. Then, the area (b) of the actual dielectric grain core is calculated. Afterwards, the “cube shape factor (C.S.F.)” of the core for one dielectric grain may be obtained by calculating the value of b/a. Next, the “average cube shape factor (A.C.S.F.)” may be obtained by calculating the average of the “cube shape factor (C.S.F.)” derived in the same method for 20 random dielectric grain cores.

### (3) Evaluation of Average Size of Dielectric Grains

When the dielectric layer in the MLCC was thin-film sampled using FIB and observed with a TEM, the average of the maximum diameters for 20 random dielectric grains was calculated and obtained.

### (4) Evaluation of Dielectric Grain Size Standard Deviation

When the dielectric layer in the MLCC was thin-film sampled using FIB and observed with a TEM, the standard deviation of the maximum diameters for 20 random dielectric grains was calculated and obtained.

### (5) Evaluation of Average Size of Dielectric Grain Core

When the dielectric layer in the MLCC was thin-film sampled using FIB and observed with a TEM, the average of the maximum diameters for 20 cores within a random dielectric grain was calculated and obtained.

### (5) Evaluation of Dielectric Grain Core Size Standard Deviation

When the dielectric layer in the MLCC was thin-film sampled using FIB and observed with a TEM, the standard deviation of the maximum diameters for 20 cores within a random dielectric grain was calculated and obtained.

### (6) Evaluation of Dielectric Grain Core Average Fraction

When the dielectric layer in the MLCC was thin-film sampled with FIB and observed with a TEM, the average of the ratio of the core area to the total area of the dielectric grains for 20 random dielectric grains was calculated and obtained.

Referring to FIGS. 8 to 13, it can be seen that in the example, the dielectric grain core had a cube shape, while in the comparative example, the dielectric grain core had a spherical shape. Additionally, in the case of the example, it can be seen that the area ratio of the core within the dielectric grain, even when observed with the naked eye, was significantly improved compared to the comparative example.

Referring to Table 2, it can be seen that in the case of Examples 1 to 4, prepared using an alcohol aqueous solution as a reaction solvent when preparing barium titanium oxide powder, the dielectric grain core has a cube shape, and the average cube shape factor (A.C.S.F.) was at an appropriate level.

In addition, it can be seen that grain growth was suppressed during the sintering process, and the average size of the dielectric grains was appropriately implemented within the range according to the present disclosure.

Conversely, in the case of Comparative Examples 1 and 2, when the barium titanium oxide powder was prepared using conventional water as the reaction solvent (hydrothermal synthesis method), it can be seen that the dielectric grain cores had a spherical shape and the average cube shape factor (A.C.S.F.) was out of the appropriate level. In addition, it can be seen that during the sintering process, the grain growth was excessive and the grain growth progressed unevenly, so that the average size of the dielectric grains was outside the range according to the present disclosure.

Meanwhile, it can be seen that in Examples 1 and 2 and Examples 3 and 4, in the case of Examples 1 and 2, where the average particle size of the titanium raw material was more appropriately controlled, the standard deviation of the dielectric grain size, etc. was more preferably implemented compared to Examples 3 and 4.

### Experimental Example 3: Evaluation of Changes in Average Size of Dielectric Grains and Sintering Relative Density of Dielectric Layer According to Changes in Sintering Temperature in the Manufacturing of the Dielectric Layer

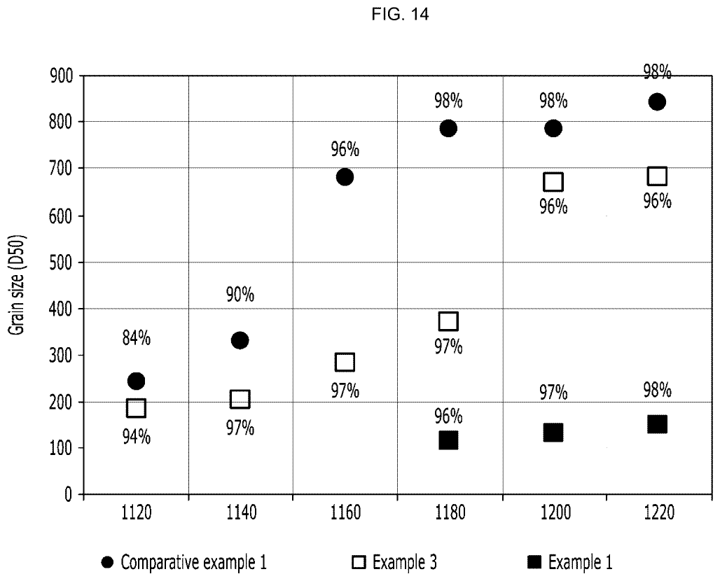

The average size of the dielectric grains in the dielectric layer and the sintering relative density of the dielectric layer were evaluated by changing the sintering temperature in the manufacturing of a multi-layered capacitor using the dielectric powder prepared according to Example 1, Example 3, and Comparative Example 1, and are shown in FIG. 14 and Table 2.

Referring to FIG. 14 and Table 2, it can be seen that the dielectric grains of Examples 1 and 3, having cube-shaped cores, may implement a superior dielectric layer sintering relative density with a relatively smaller sintering temperature and dielectric grain average size compared to the dielectric grains of Comparative Example 1, having spherical cores.

Meanwhile, it can be seen that in Example 1 and Example 3, the above effect is more preferably implemented in Example 1, where the average particle diameter of the titanium raw material is more appropriately controlled, compared to Example 3.

### Experimental Example 4: MLCC Performance Evaluation

### (1) Evaluation of DC Variation Ratio (1 V, 3 V/μm)

The DC variation ratio was evaluated by maintaining DC in a 1 kHz 1 V AC electric field for 60 s.

### (2) Evaluation of Step IR MTTF

Step insulation resistance (IR) mean time to failure (MTTF) was evaluated by maintaining each step for 1200 s at 125° C. and 1.5 Vr.

### (3) Evaluation of Temperature Coefficient of Capacitance (TCC) Capacity Variation Ratio (−55° C./125° C.)

After heat treatment at 150° C. for 2 hours, aging for 24 hours and measuring at −55, 25, and 85° C. for 5 minutes under 1 kHz 0.5 V conditions, the TCC capacity variation ratio was evaluated.

Referring to Table 3, it can be seen that in Examples 1 to 4, which had a cube-shaped barium titanium oxide-containing core and the average size of the dielectric grains was appropriately controlled within the range according to the present disclosure, the MLCC performance was excellent overall.

On the other hand, it can be seen that in Comparative Examples 1 and 2, which had a conventional spherical barium titanium oxide-containing core and the average size of the dielectric grains was outside the range according to the present disclosure, the MLCC performance was significantly deteriorated overall compared to the examples.

Comparing the examples in more detail, it can be seen that in Examples 1 and 2, where the standard deviation of the dielectric grain size was more appropriately controlled, the DC variation rate and Step IR MTTF characteristics were more preferably implemented compared to Examples 3 and 4.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

Therefore, the actual scope of the present disclosure will be defined by the appended claims and their equivalents.

What is claimed is:

1. A multi-layered capacitor, comprising:
a capacitor body including a dielectric layer and an internal electrode; and
an external electrode disposed outside the capacitor body and on the capacitor body,
wherein the dielectric layer includes a plurality of dielectric grains, and
the plurality of dielectric grains include a cube-shaped core that includes a component including barium (Ba) and titanium (Ti) oxide.

2. The multi-layered capacitor of claim 1, wherein
a surface of the core includes predominantly a (001) crystal plane.

3. The multi-layered capacitor of claim 1, wherein
the plurality of dielectric grains have an average size of 160 nm or less.

4. The multi-layered capacitor of claim 1, wherein
a standard deviation of a size of the plurality of dielectric grains is 40 nm or less.

5. The multi-layered capacitor of claim 1, wherein
the core has an average size of 120 nm or less.

6. The multi-layered capacitor of claim 1, wherein
a standard deviation of a size of the core is 30 nm or less.

7. The multi-layered capacitor of claim 1, wherein
an average fraction of the core within the plurality of dielectric grains is 60% or more.

8. The multi-layered capacitor of claim 1, wherein
the multi-layered capacitor satisfies Equation 1 below:
[Equation 1]
Dₛ/D_{avg}≥0.7 (%/nm)
wherein in Equation 1, Dₛ is a sintering relative density of the dielectric layer, and D_{avg} is an average size of the plurality of dielectric grains.

9. The multi-layered capacitor of claim 1, wherein
an average size of the plurality of dielectric grains is 200 nm or less when a sintering relative density of the dielectric layer is 98%.

10. The multi-layered capacitor of claim 1, wherein
the plurality of dielectric grains further comprise a shell disposed on the core, and the shell includes Dy, Mg, Mn, Tb, Sm, Si, Ba, Al, V, Nb, Sn, or a combination thereof.

11. The multi-layered capacitor of claim 1, wherein the component is represented by the following Chemical Formula 1:
[Chemical Formula 1]
Ba₍₁₋ₓ₎D1ₓTi_{(1-y)}D2_{y}O₃
in Chemical Formula 1, D1 is Dy, Tb, Sm, Nb, or a combination thereof, D2 is Mg, Mn, Si, Al, V, Dy, Tb, Sm, Sn, or a combination thereof, 0≤x≤0.3, and 0≤y≤0.3.

12. A multi-layered capacitor, comprising:
a capacitor body including a dielectric layer and an internal electrode; and
an external electrode disposed outside the capacitor body and on the capacitor body,
wherein the dielectric layer includes a plurality of dielectric grains, and
the plurality of dielectric grains include a cube-shaped core that includes a component including barium (Ba).

13. The multi-layered capacitor of claim 12, wherein
the component further includes titanium and oxygen.

14. The multi-layered capacitor of claim 13, wherein the component is represented by the following Chemical Formula 1:
[Chemical Formula 1]
Ba₍₁₋ₓ₎D1ₓTi_{(1-y)}D2_{y}O₃
in Chemical Formula 1, D1 is Dy, Tb, Sm, Nb, or a combination thereof, D2 is Mg, Mn, Si, Al, V, Dy, Tb, Sm, Sn, or a combination thereof, 0≤x≤0.3, and 0≤y≤0.3.

15. The multi-layered capacitor of claim 14, wherein:
the plurality of dielectric grains have an average size of 160 nm or less,
a standard deviation of a size of the plurality of dielectric grains is 40 nm or less,
the core has an average size of 120 nm or less,
a standard deviation of a size of the core is 30 nm or less,
an average fraction of the core within the plurality of dielectric grains is 60% or more, and
a sintering relative density of the dielectric layer is 95% or more and not more than 100%.

16. A method of manufacturing a multi-layered capacitor, comprising:
mixing a first precursor including barium, a second precursor including titanium, alcohol, and water to form a reaction solution,
heating the reaction solution to form cube-shaped particles including barium and titanium,
forming a dielectric green sheet from a dielectric paste that includes the particles,
forming a conductive paste layer on a surface of the dielectric green sheet,
stacking a plurality of the dielectric green sheets having the conductive paste layer to prepare a dielectric green sheet laminate,
firing the dielectric green sheet laminate to manufacture a capacitor body, and
forming an external electrode on a surface of the capacitor body.

17. The method of claim 16, wherein the alcohol includes at least one selected from methanol, ethanol, propanol, butanol, pentanol.

18. The method of claim 17, wherein the first precursor includes at least one selected from Ba(OH)₂, Ba(OH)₂·8H₂O, and BaCl₂.

19. The method of claim 18, wherein the second precursor includes at least one selected from TiO₂, titanium isopropoxide, titanium (IV) bis (ammonium lactato) dihydroxide, and TiCl₄.

20. The method of claim 19, wherein the dielectric paste further includes hafnium (Hf).

21. The method of claim 20, further comprising, after the heating of the reaction solution, coating the particles with Dy, Mg, Mn, Tb, Sm, Si, Ba, Al, V, Nb, Sn, or a combination thereof.
